(19) United States
(12) Patent Application Publication
(10) Pub. No.: US 2014/0366744 A1
(43) Pub. Date: Dec. 18, 2014

(54) BEVERAGE MACHINE TURNTABLE PAD

(71) Applicant: JOBAR INTERNATIONAL, INC., Carson, CA (US)

(72) Inventor: MITCHELL FOSTER SUSSMAN, Rolling Hills Estates, CA (US)

(21) Appl. No.: 14/300,748

(22) Filed: Jun. 10, 2014

Related U.S. Application Data
(60) Provisional application No. 61/836,002, filed on Jun. 17, 2013.

(51) Int. Cl. A47J 31/40

(52) U.S. Cl. CPC A47J 31/407
USPC 99/290

(57) ABSTRACT

A beverage machine turntable pad includes a housing having a first wall for supporting a beverage machine, a support rotatably coupled to the housing below the first wall, such that the support is rotatable about a rotational axis relative to the housing, and a plurality of adjacent drawers mounted on the support, each of the drawers being capable of extending and retracting relative to the support and radially relative to the rotational axis and through a housing opening formed through the housing.

### CROSS-REFERENCE TO RELATED APPLICATION

This application claims priority to and the benefit of Provisional Application No. 61/836,002, filed on Jun. 17, 2013, the entire disclosure of which is incorporated herein by reference.

### BACKGROUND

Newer beverage machines, such as coffee brewing machines such as those that use coffee pots require that such pads are stored somewhere. Often, these pads are stored in drawers away from the coffee maker. Other items such as sugar, etc., are stored away from the coffee maker. Thus, a storage system that occupies a lot of space and that can be adjacent to such coffee maker to hold such coffee related items is desired.

### SUMMARY

In an example embodiment a beverage machine turntable pad is provided. The turntable pad includes a housing having a first surface on a first wall for supporting a beverage machine, a support rotatably coupled to the housing below the first wall, such that the support rotates about a rotational axis relative to the housing, and a plurality of adjacent drawers mounted on the support, each of the drawers being capable of extending and retracting relative to the support is rotatable relative to the rotational axis and through a housing opening formed through the housing. In another example embodiment, the housing includes a second surface formed on a second wall opposite and spaced apart from the first wall and a peripheral wall extending between the first and second walls. In this embodiment, the housing opening is formed at least through the peripheral wall. In yet another example embodiment, the turntable pad further includes a post extending from the second surface toward the first surface. In a further embodiment, the support includes an opening penetrated by the post. In yet a further embodiment, the turntable pad also includes at least one annular track on the second surface, such that the support is on the at least one annular track and rotates on the at least one annular track. In one example embodiment, the support includes at least one support track for each drawer, each of the at least one support tracks extend outward, and each of the drawers includes at least one drawer track for mating with, and sliding relative to, a corresponding support track. In another example embodiment, the support includes at least two support tracks for each drawer, and the drawer track on each drawer defines a dove tail mating with the support tracks, such that the dove tail has a first portion and a second portion, and at least a portion of a first of the support tracks extends over the first portion of the dove tail, and at least a portion of second of the support tracks extends over the second portion of the dove tail. In yet another example embodiment, the at least one support track for each drawer on the support is a dove tail, and the at least one drawer track on each of the drawers is two drawer tracks on each drawer for mating with the a corresponding dove tail of the support, such that the dove tail has a first portion and a second portion, where at least a portion of a first of the drawer tracks extends below the first portion of the dove tail, and at least a portion of second of the drawer tracks extends below the second portion of the dove tail. In a further example embodiment, only a single drawer can extend through the housing opening when the drawer is aligned with the housing opening. In yet a further example embodiment, each drawer has a first mark and wherein the first surface has a second mark, such that when the mark of one of the plurality of drawers is aligned with the mark on the first surface, the one drawer of the plurality of drawers can be extended through the housing opening. In another example embodiment, the first mark is a cut-out formed on the first wall and wherein the second mark is a cut-out. Any of the aforementioned embodiments may be provided in combination with a beverage machine, such as a brewing machine. Examples of beverage machines include but are not limited to coffee, tea and hot chocolate brewing machines.

### BRIEF DESCRIPTION OF THE DRAWINGS

FIG. 1 is a perspective view of a turntable pad of an example embodiment of the present invention.

FIG. 2 is a perspective view of a lower piece of the example turntable pad shown in FIG. 1 depicting drawers mounted thereon.

FIG. 3 is a perspective cutaway view showing a support rotatably mounted on a lower wall of an example embodiment turntable pad shown in FIG. 1.

FIG. 4A is a perspective view depicting a lower section of the housing of the example embodiment turntable pad shown in FIG. 1.

FIG. 4B is a perspective view depicting another example embodiment lower section of the housing of the example embodiment turntable pad shown in FIG. 1.

FIG. 5 is a partial cross-sectional view depicting sliding engagement between a drawer and a support of the example embodiment turntable pad shown in FIG. 1.

FIG. 6 is a partial cross-section view of another example embodiment sliding connection between a drawer and a support of an example embodiment turntable pad.

FIG. 7 is a perspective view of a housing of the example embodiment turntable pad shown in FIG. 1.

FIG. 8 is a partial perspective view of an upper piece of housing (shown upside down) of the example embodiment turntable pad shown in FIG. 1.

FIG. 9 is a partial cross-sectional view depicting a connection between an upper and a lower piece forming a housing of the example embodiment turntable pad shown in FIG. 1.

FIG. 10 is a front view of a coffee brewing machine supported by an example embodiment coffee turntable pad.

FIGS. 11A and 11B disclose a perspective view and a top view, respectively, of example pods for use with an example embodiment turntable pad.

### DETAILED DESCRIPTION

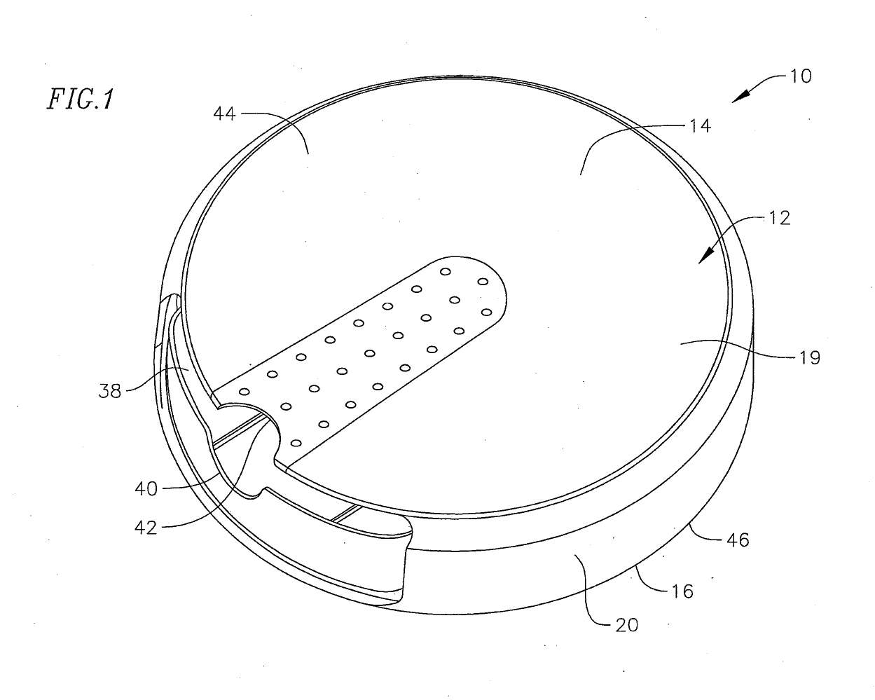

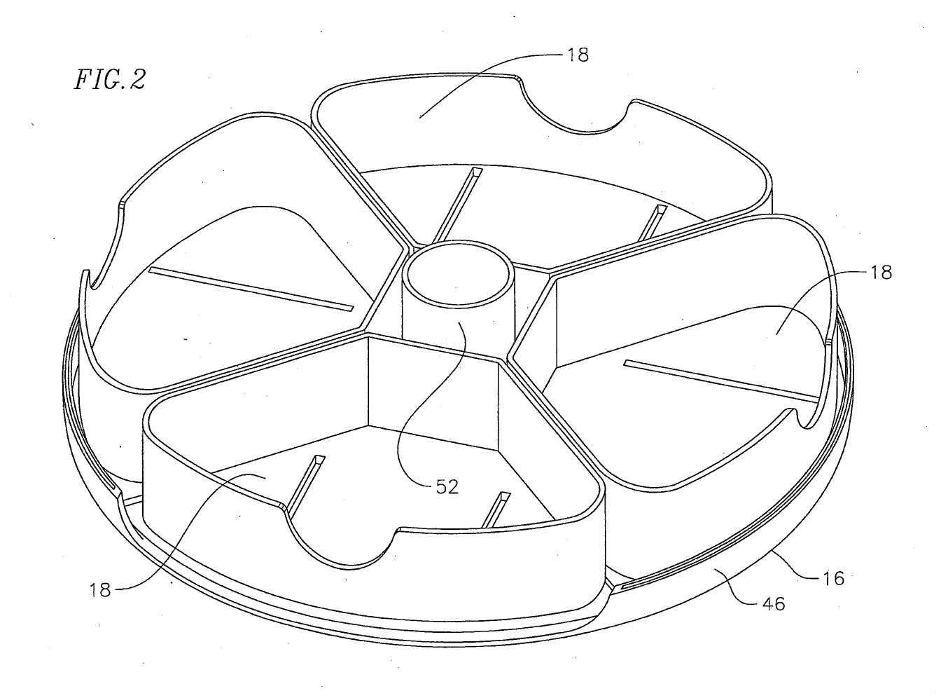

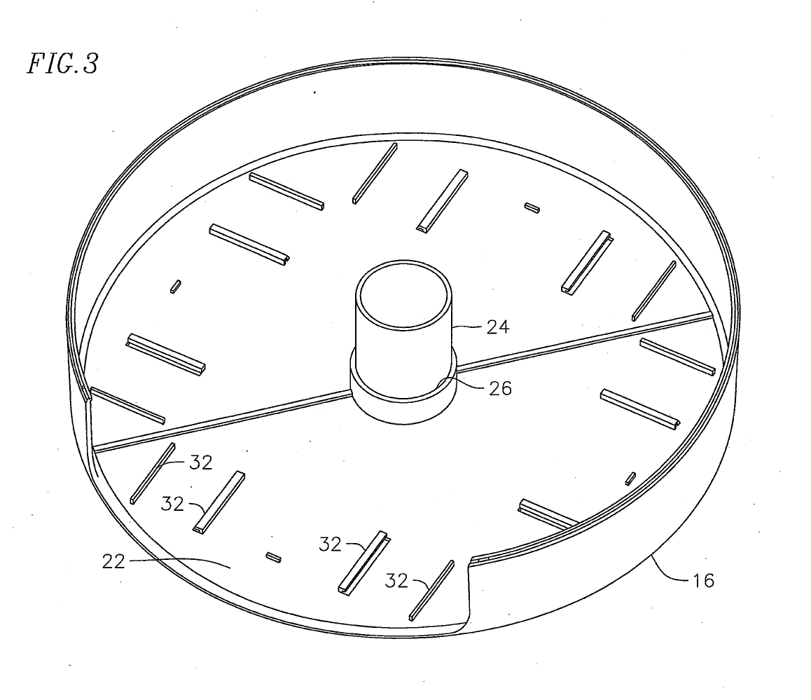

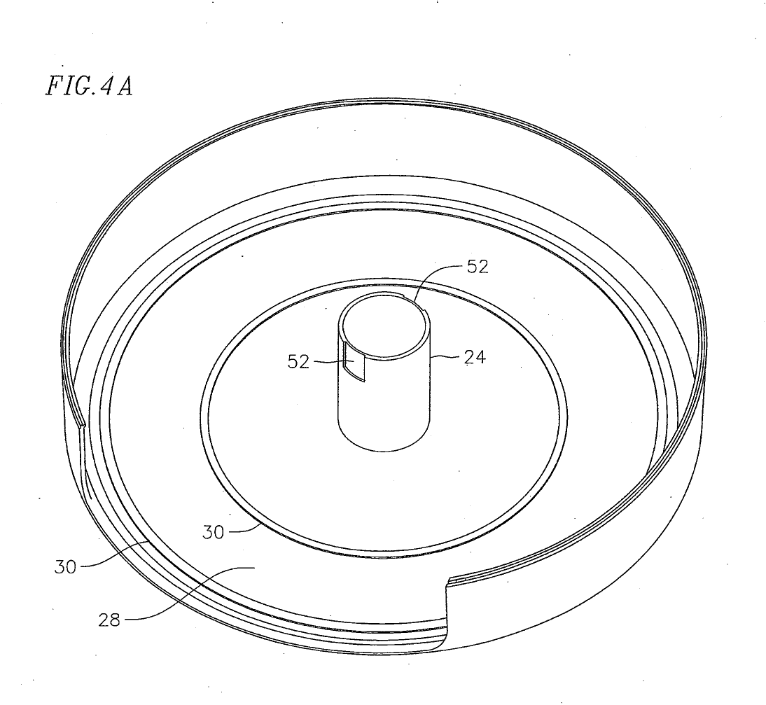

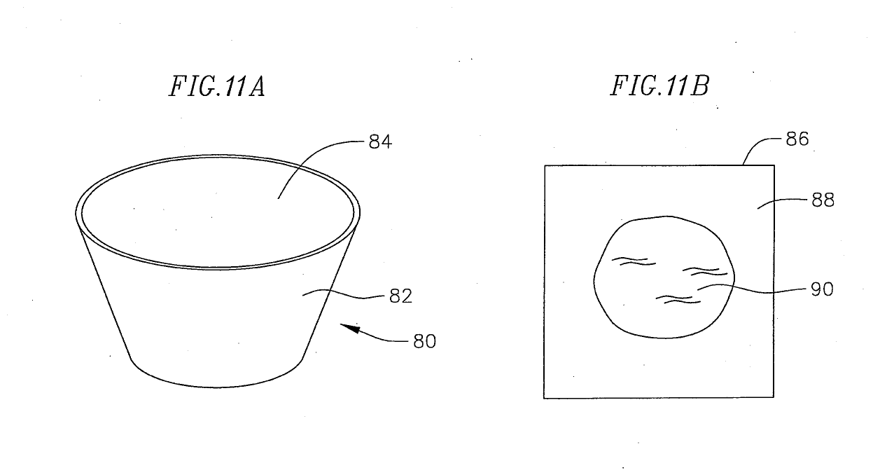

A coffee maker supporting turntable pad 10 is provided (FIG. 1). The pad is described for use with a coffee maker for storing coffee pods for illustration purposes. The pad may be used with other devices such as teamakers, or hot chocolate makers, or other beverage making devices for example and may house other type pods such as tea pods or hot chocolate pods or any other type of beverage pods including tea bags. In an example embodiment, the turntable pad includes a housing 12 which includes an upper or first wall 14, on which may be rested a coffee brewing machine, opposite a second wall 16. In an example embodiment, the turntable includes drawers 18 (FIG. 2). In an example embodiment, the turntable pad is meant for use with a brewing machine which uses pods. Pods may have different shapes and are well known. For example pods 80 may have a cup-shaped body 82 housing coffee which is covered by a covering 84, as for example shown in FIG. 11A. Other pods 86 may have a generally polygonal body 88 housing the coffee in a bulge 90, as for example shown in FIG. 11B. Such pods are typically provided in sealed enclosures. Other pods may have other shapes. The drawers in an example embodiment pad may be used to house the pods. For example, different drawers may be used to house different types of coffee pods or different flavored coffee pods. The housing first wall 14 forms a coffee brewing machine interfacing surface 19 while the second wall or base wall 16 defines a base. The two walls are interconnected by a peripheral wall 20. The peripheral wall may be integrally formed with either or both of the first and second walls 14, 16. A support member, or plate 22, defining a turntable is rotatably mounted relative to the base wall, such that it can rotate relative to the base wall (FIG.3). In an example embodiment, a post 24 extends internally and vertically from an inner surface 28 of the base wall 16. The support member includes an opening 26 which is penetrated by the post. In a further embodiment, at least one circular track 30 extends internally from the inner surface 28 of the base wall (FIG. 4A). As shown in FIG. 4A, two concentric circular tracks 30 extend from the inner surface of the base wall. When mounted on the base surface, the support member slides along the circular track and is thus spaced from the inner surface 28 of the base wall. By being spaced apart from the inner surface, the support member 22 can rotate around the post relative to the base member easier with less drag or friction.

In another example embodiment as shown in FIG. 4B, instead of a track 30, an annular cage 31 is fitted within an annular groove 33. The annular cage 31 supports a plurality of roller bearing balls 35. In this regard, the annular cage can rotate along the annular groove and the roller balls which also simultaneously rotate reduce the friction between the annular cage and a lower surface of the groove. As such, when mounted over the base surface, the support member rests against the annular cage. Thus, due to the weight of the support member against the annular cage, rotation of the support member causes the annular cage to rotate within the annular groove. The roller bearings allow the annular cage, as well as the support member to rotate relative to the inner surface 28 of the base wall, easier with less drag or friction.

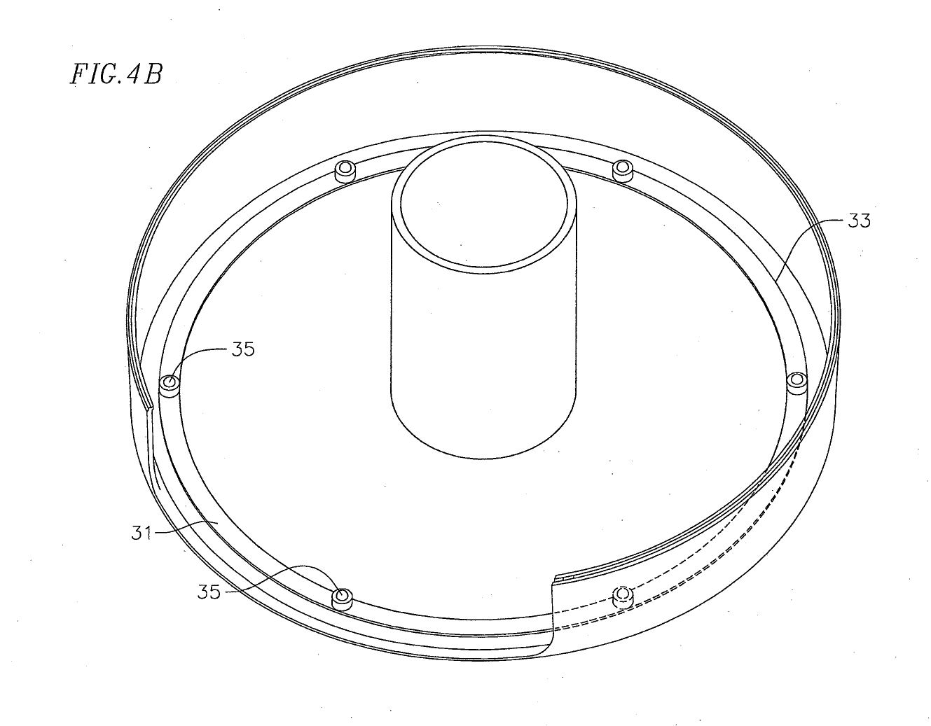

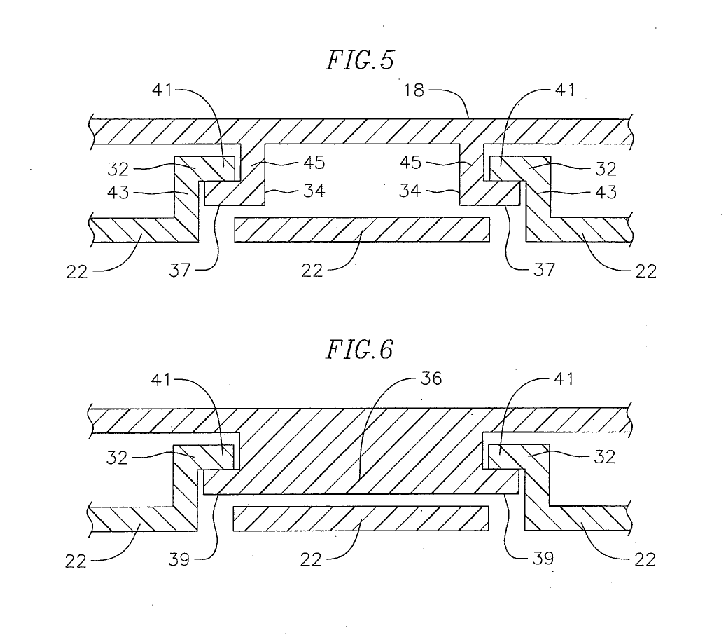

The support member 22 is designed for slidably supporting the plurality of drawers 18. In the shown example embodiment, the support member is designed for supporting four drawers 18. In another example embodiment, the support surface may be designed to support any number of drawers. In an example embodiment, each of the drawers is coupled to the support around the post 24, and each has a truncated pie-shape in plan view. In an example embodiment, for each drawer, the support includes at least one support track 32 and each drawer also includes one drawer track 34 for mating with the support track 32 so that the drawer can slide radially relative to the post and extend and retract relative to the support member (FIGS. 3 and 5). In an example embodiment shown in FIG. 3, for each drawer, the support member 22 includes two pairs of tracks 32 (or four tracks 32). In one example embodiment, each drawer track 34 has a portion 37 for sliding below a portion 41 of a corresponding support track. In this regard, the support track retains the drawer track from moving in a direction away from the support member. In the example embodiment shown in FIG. 5, the support track portions 41 extend transversely toward each other and from vertical portions 43 of their support tracks 32, while the drawer track portions 37 extend transversely away from each other and from vertical portions 45 of the drawer track portions 37. In other example embodiments, the support track portions 41 extend away from each other while the drawer track portions 37 extend toward each other. In another example embodiment, each drawer has a dovetail projection 36 defining a pair of opposite tracks 39 for interfacing with two support tracks 32, as for example shown in FIG. 5. In an example embodiment, each drawer has two dovetail projections 36 for slidably interfacing with the two pairs of support tracks 32, as for example shown in FIG. 3. Other coupling arrangements known in the art may be used for coupling each drawer to the support member. For example, dove tail projections may extend from the support member for slidably engaging tracks extending from the drawers. As can be seen with the example embodiments, the drawers can extend and retract radially relative to the support member.

In an example embodiment, an opening 38 is formed at least through the peripheral wall 20 (FIG. 1). The opening is of a size that will only allow one drawer 18 to extend therethrough at a time. For a drawer 18 to be able to extend through the opening and outside the housing 12, the drawer 18 must be aligned with the opening 20. In an example embodiment, each drawer is provided with a marking 40 and a marking 42 is provided on the housing, as for example on the upper wall 14 of the housing. When the marking on the drawer is aligned with the marking on the housing, the drawer is in a position to be extended relative to the support, and thus, the housing through the housing opening. In an example embodiment, the markings are a cut-out formed on the upper wall of the housing, as well as a cut-out formed on the drawer. The cut-out also allows a user to use his finger to penetrate the cut-outs and pull and extend the drawer open, as well as rotate the drawers relative to the housing.

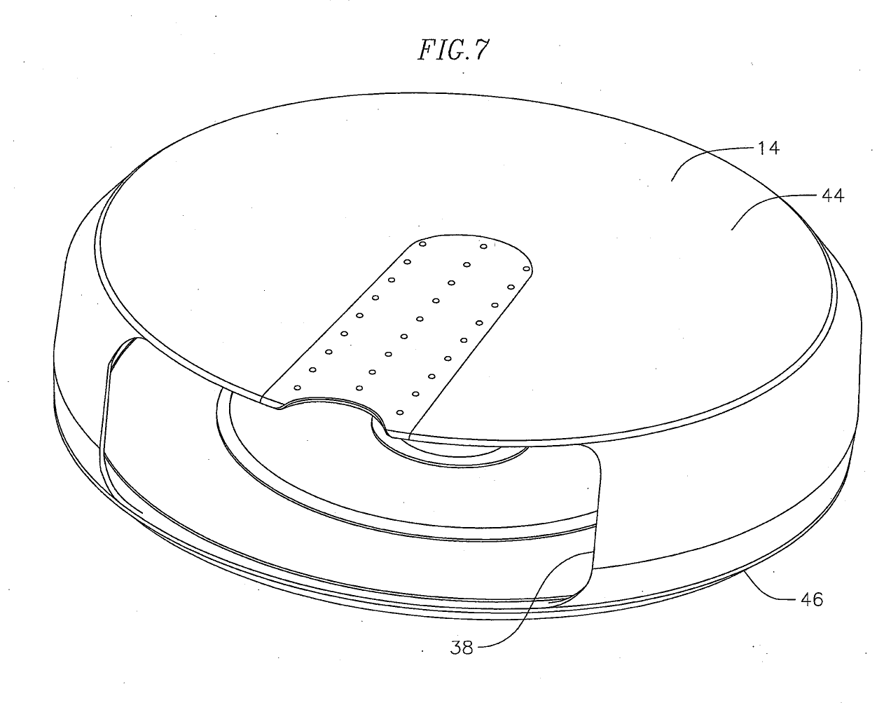

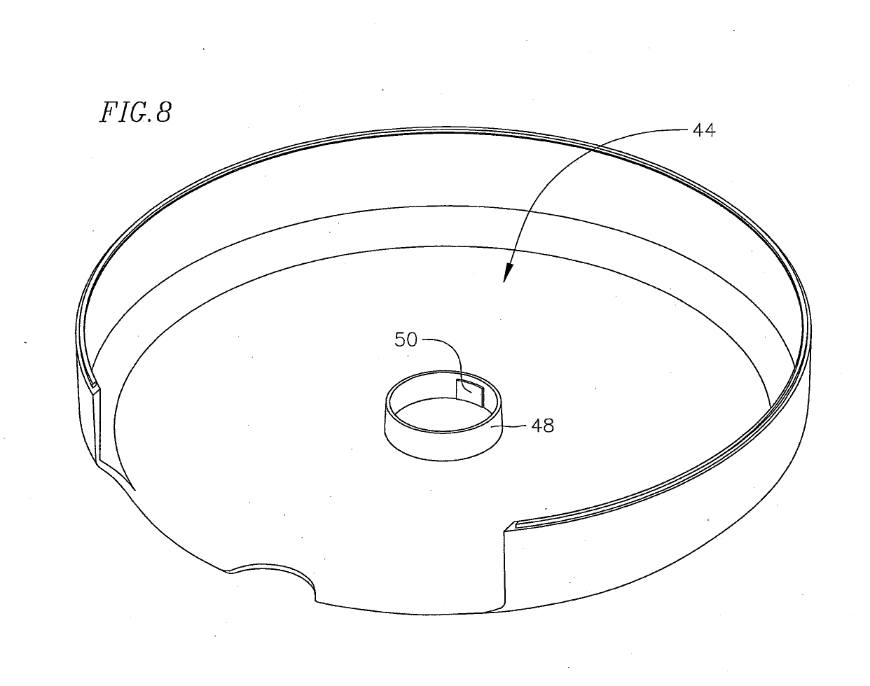

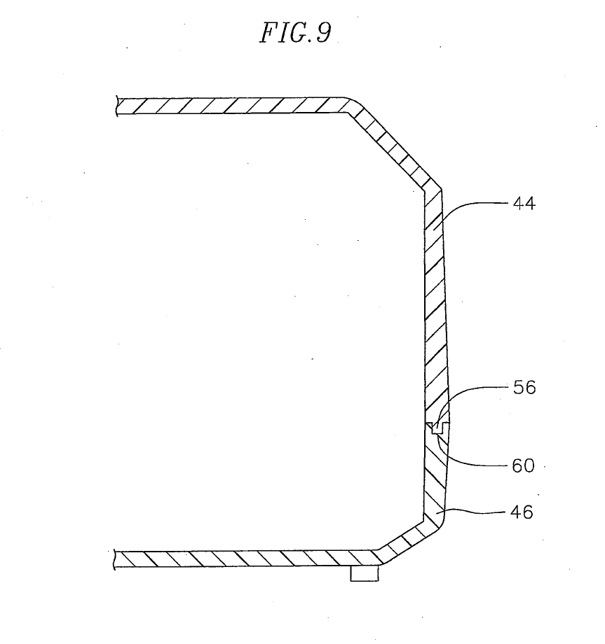

In an example embodiment, the housing may be formed in two pieces: an upper piece 44 which includes the upper wall and a lower piece 46 which includes the base wall 16 (FIG. 7). The upper and lower pieces are then connected to each other and define the opening 38. The connection may be done with any well-known methods. In an example embodiment, the upper piece is adhered to the lower piece. The two pieces may mate with each other through a post 56 and groove 60 type connections, as for example shown in FIG. 9. In an example embodiment, the upper piece also includes an annular sleeve 48 for receiving the post 24 extending from the base wall when the upper piece is mated to the lower piece. In an example embodiment, at least one spline 50 is formed inside the annular sleeve 48 for mating with a pocket 52 formed on the post 24. In an example embodiment, two splines 50 opposite each other are formed inside the annular sleeve 48 for mating with two opposite pockets 52 (FIGS. 2 and 4A) formed on the post 24. Each spline 50 slides within its corresponding pocket 52 when the upper piece is mated with the lower piece serving to guide the two pieces together and to prevent them from rotating (at least to any significant degree) relative to each other and ensure that they are properly aligned relative to each to other to define the opening 38. In other example embodiments, the spline(s) 50 may be formed in the post 24, and the pocket(s) 52 inside the annular sleeve 48.

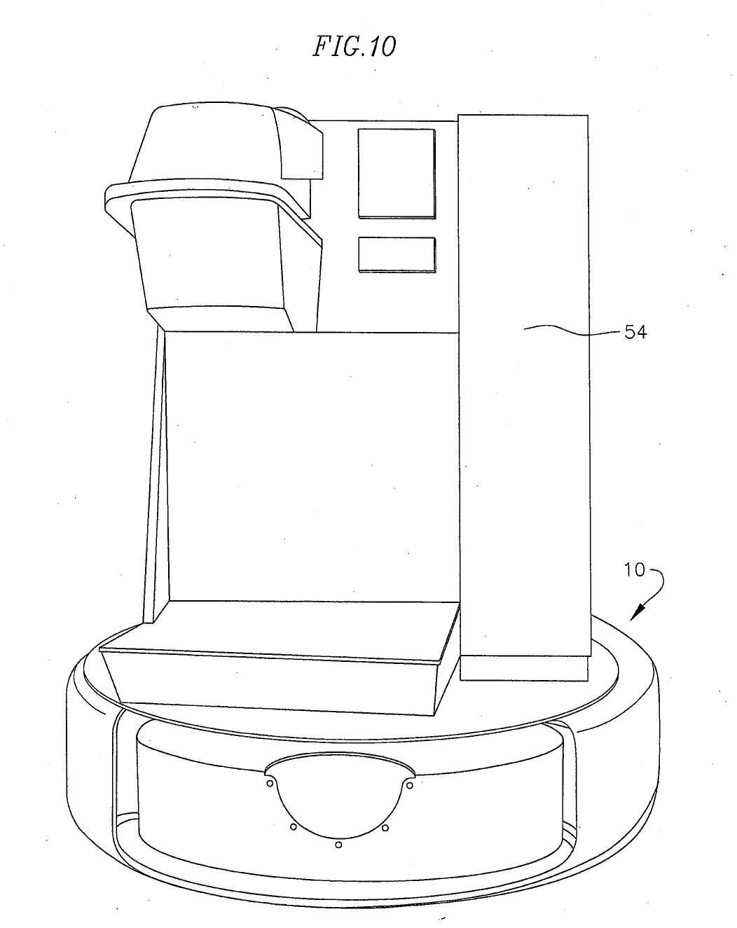

In an example embodiment, the turntable pod is made for use with a coffee brewing machine 54 that uses coffee pods, as for example shown in FIG. 10. In such case, each tray may be filled with pods of a different type of coffee. A user may then rotate the turntable (i.e., the support member 22) with the drawers, such that the drawer containing the coffee pods that he/she likes is aligned with the marking and then opens the drawer to obtain an appropriate pod of coffee.

In an example embodiment, the coffee interfacing surface 19 of the first wall may be formed with specific types of coffee makers in mind having a sufficient size to support such coffee makers. In another example, the interface surface may be formed or molded into a shape that is complementary the base of a coffee maker. In addition, the interfacing surface 19 may include a surface that provides higher friction for preventing the beverage machines (e.g., coffee maker) from sliding off. In one example embodiment, the interfacing surface may be made from rubber or a rubber-like material or include a section or sections of rubber or rubber-like material, or other similar materials.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A beverage machine turntable pad and brewing machine combination comprising:
a beverage machine;
a housing having a first surface on a first wall supporting said beverage machine;
a support rotatably coupled to the housing below the first wall, wherein the support is rotatable about a rotational axis relative to the housing; and
a plurality of adjacent drawers mounted on the support, each of said drawers being capable of extending and retracting relative to the support and radially relative to the rotational axis and through a housing opening formed through the housing.

2. The combination of claim 1, wherein the housing comprises a second surface on a second wall opposite and spaced apart from the first wall and a peripheral wall extending between the first and second walls, wherein the housing opening is formed at least through the peripheral wall.

3. The combination of claim 2, further comprising a post extending from a second surface formed on the second wall toward the first wall.

4. The combination of claim 3, wherein the support comprises an opening penetrated by said post.

5. The combination of claim 4, further comprising at least one annular track on said second surface, wherein said support is on said at least one annular track and rotates on said at least one annular track.

6. The combination of claim 5, wherein said support comprises at least one support track for each drawer, each of said at least one support tracks extend outward, and wherein each of said drawers comprises at least one drawer track for mating with, and sliding relative to, a corresponding support track.

7. The combination of claim 6, wherein said support comprises at least two support tracks for each drawer, and wherein said drawer track on each drawer defines a dove tail mating with said support tracks, wherein said dove tail has a first portion and a second portion, wherein a at least a portion of a first of said support tracks extends over the first portion of said dove tail, and at least a portion of second of said support tracks extends over the second portion of the dove tail.

8. The combination of claim 6, wherein said at least one support track for each drawer on said support is a dove tail, and wherein said at least one drawer track on each of said drawers is two drawer tracks on each drawer for mating with said corresponding dove tail of said support, wherein said dove tail has a first portion and a second portion, wherein at least a portion of a first of said drawer tracks extends below the first portion of said dove tail, and at least a portion of second of said drawer tracks extends below the second portion of the dove tail.

9. The combination of claim 1, wherein only a single drawer can extend through said housing opening when said drawer is aligned with said housing opening.

10. The combination of claim 9, wherein each drawer has a first mark and wherein the first surface has a second mark, wherein when the mark of one of said plurality of drawers is aligned with the mark on said first surface, said one drawer of said plurality of drawers can be extended through said housing opening.

11. The combination of claim 10, wherein the first mark is a cut-out on the first wall and wherein the second mark is a cut-out.

12. A beverage machine turntable pad comprising:
a housing having a first surface on a first wall supporting a beverage machine;
a support rotatably coupled to the housing below the first surface, wherein the support is rotatable about a rotational axis relative to the housing; and
a plurality of adjacent drawers mounted on the support, each of said drawers being capable of extending and retracting relative to the support and radially relative to the rotational axis and through a housing opening formed through the housing.

13. The turntable pad of claim 12, wherein the housing comprises a second wall opposite and spaced apart from the first wall and a peripheral wall extending between the first and second walls, wherein the housing opening is formed at least through the peripheral wall.

14. The turntable pad of claim 13, further comprising a post extending from a second surface formed on the second wall toward the first wall.

15. The turntable pad of claim 14, wherein the support comprises an opening penetrated by said post.

16. The turntable pad of claim 15, further comprising at least one annular track on said second surface, wherein said support is on said at least one annular track and rotates on said at least one annular track.

17. The turntable pad of claim 16, wherein said support comprises at least one support track for each drawer, each of said at least one support tracks extend outward, and wherein each of said drawers comprises at least one drawer track for mating with, and sliding relative to, a corresponding support track.

18. The turntable pad of claim 12, wherein only a single drawer can extend through said housing opening when said drawer is aligned with said housing opening.

19. The turntable pad of claim 18, wherein each drawer has a first mark and wherein the first surface has a second mark, wherein when the mark of one of said plurality of drawers is aligned with the mark on said first surface, said one drawer of said plurality of drawers can be extended through said housing opening.

20. The turntable pad of claim 19, wherein the first mark is a cut-out on the first wall and wherein the second mark is a cut-out.
